(19) United States
(12) Patent Application Publication
(10) Pub. No.: US 2014/0321446 A1
(43) Pub. Date: Oct. 30, 2014

(54) CONNECTION INFORMATION CONTROL METHOD AND ELECTRONIC DEVICE THEREFOR

(71) Applicant: Samsung Electronics Co., Ltd., Suwon-si (KR)

(72) Inventors: Dong-Il SON, Seongnam-si (KR); Jae-Yung YEO, Seongnam-si (KR)

(73) Assignee: Samsung Electronics Co., Ltd., Suwon-si (KR)

(21) Appl. No.: 14/224,559

(22) Filed: Mar. 25, 2014

(30) Foreign Application Priority Data
Apr. 29, 2013 (KR) 10-2013-0047632

(51) Int. Cl. H04W 48/08

(52) U.S. Cl. CPC H04W 48/08
USPC 370/338

(57) ABSTRACT

A method and an apparatus for controlling connection information stored in an electronic device is provided. The method includes determining connection information, for at least one local-area wireless communication device, stored in the electronic device, selecting the connection information, for the at least one local-area wireless communication device, to be transmitted to a counterpart electronic device, and transmitting the connection information to the counterpart electronic device.

### CROSS-REFERENCE TO RELATED APPLICATION(S)

This application claims the benefit under 35 U.S.C. §119(a) of a Korean patent application filed on Apr. 29, 2013 in the Korean Intellectual Property Office and assigned Serial number 10-2013-0047632, the entire disclosure of which is hereby incorporated by reference.

### TECHNICAL FIELD

The present disclosure relates to a method and an apparatus for controlling connection information stored in an electronic device. More particularly, the present disclosure relates to a connection information control method for performing a connection with a local-area wireless communication device and an electronic device therefor.

### BACKGROUND

As communication technologies continue to advance, many small portable electronic devices have been manufactured. Portable electronic devices, such as mobile phones, Personal Digital Assistants (PDAs), Personal Multimedia Players (PMPs), and the like, may transmit and receive information with counterpart electronic devices. More particularly, each of the electronic devices drives application programs in addition to original functions to accommodate needs of various consumers. Accordingly, connection with a corresponding counterpart electronic device is often needed.

Recently, as applications or services (e.g., streaming or file transfer using Digital Living Network Appliances (DLNAs), and the like) using a Wireless-Fidelity (Wi-Fi) network have increased, the number of times that users connect to wireless Access Points (APs) has also increased. The majority of the wireless APs to which various users connect are Wi-Fi APs to which various security settings including a Wi-Fi Protected Access (WPA), a WPA2, and a Wired Equivalent Privacy (WEP) are applied. Information including a Service Set IDentification (SSID) and password of a corresponding network is needed to connect to the Wi-Fi APs to which the security settings are applied.

Each of the users receives information about the Wi-Fi AP verbally or through a medium, such as a messenger, an e-mail, and the like. Although each of the users has the information about the Wi-Fi AP, he or she needs to move to a place where there is a corresponding Wi-Fi network, perform a scan operation, and input the received information to connect to the corresponding Wi-Fi network. In addition, when a plurality of users connect to one network, there is a problem in that connection information about the network needs to be separately informed to them.

Therefore, an interface, which may control connection information about a local-area wireless communication device, is needed in an electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a connection information control method for performing a connection with a local-area wireless communication device and an electronic device therefor.

Another aspect of the present disclosure is to provide a connection information control method for including authentication information in connection information and an electronic device therefor.

Another aspect of the present disclosure is to provide a connection information control method for including validity information in connection information and an electronic device therefor.

Another aspect of the present disclosure is to provide a connection information control method for transmitting connection information to a counterpart electronic device and an electronic device therefor.

Another aspect of the present disclosure is to provide a connection information control method for performing a connection with a local-area wireless communication device using connection information received from a counterpart electronic device and an electronic device therefor.

In accordance with an aspect of the present disclosure, a method for controlling connection information stored in an electronic device is provided. The method includes determining the connection information, for at least one local-area wireless communication device, stored in the electronic device, selecting the connection information, for the at least one local-area wireless communication device, to be transmitted to a counterpart electronic device and transmitting the connection information to the counterpart electronic device.

In accordance with another aspect of the present disclosure, a method for controlling connection information stored in an electronic device is provided. The method includes receiving connection information for at least one local-area wireless communication device from a counterpart electronic device and performing a connection with the at least one local-area wireless communication device using the connection information.

In accordance with another aspect of the present disclosure, an electronic device is provided. The electronic device includes at least one processor, a memory, and at least one program stored in the memory and configured to be executable by the at least one processor, wherein the at least one processor determines connection information, for at least one local-area wireless communication device, stored in the electronic device, selects the connection information, for the at least one local-area wireless communication device, to be transmitted to a counterpart electronic device, and transmits the connection information to the counterpart electronic device.

In accordance with another aspect of the present disclosure, an electronic device is provided. The electronic device includes at least one processor, a memory, and at least one program stored in the memory and configured to be executable by the at least one processor, wherein the at least one processor receives connection information for at least one local-area wireless communication device from a counterpart electronic device and performs connection with the at least one local-area wireless communication device using the connection information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a system for controlling connection information according to an embodiment of the present disclosure;

FIG. 2 is a block diagram illustrating a configuration of an electronic device according to an embodiment of the present disclosure;

FIG. 3 is a block diagram illustrating a configuration of a processor according to an embodiment of the present disclosure;

FIG. 4A is a flowchart illustrating a process of transmitting connection information to a counterpart electronic device in an electronic device according to an embodiment of the present disclosure;

FIG. 4B is a block diagram illustrating a configuration of an electronic device for transmitting connection information to a counterpart electronic device according to an embodiment of the present disclosure;

FIG. 5 is a flowchart illustrating a process of transmitting connection information to a counterpart electronic device in an electronic device according to an embodiment of the present disclosure;

FIG. 6 is a flowchart illustrating a process of transmitting connection information including authentication information to a counterpart electronic device in an electronic device according to an embodiment of the present disclosure;

FIG. 7 is a flowchart illustrating a process of transmitting connection information including validity information to a counterpart electronic device in an electronic device according to an embodiment of the present disclosure;

FIG. 8A is a flowchart illustrating a process of performing a connection with a local-area wireless communication device using connection information received from a counterpart electronic device in an electronic device according to an embodiment of the present disclosure;

FIG. 8B is a block diagram illustrating a configuration of an electronic device for performing a connection with a local-area wireless communication device using connection information received from a counterpart electronic device according to an embodiment of the present disclosure;

FIG. 9 is a flowchart illustrating a process of performing a connection with a local-area wireless communication device using connection information received from a counterpart electronic device in an electronic device according to an embodiment of the present disclosure;

FIG. 10 is a flowchart illustrating a process of performing a connection with a local-area wireless communication device using connection information including authentication information received from a counterpart electronic device in an electronic device according to an embodiment of the present disclosure; and

FIGS. 11A, 11B, 11C, and 11D are screens illustrating a process of controlling connection information stored in an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Hereinafter, a description will be given for a method and an apparatus for controlling connection information stored in an electronic device.

Hereinafter, the electronic device may be any one of a mobile communication terminal, a Personal Digital Assistant (PDA), a laptop, a smart phone, a netbook, a television, a Mobile Internet Device (MID), an Ultra Mobile Personal Computer (UMPC), a tablet PC, a navigation device, a Moving Picture Experts Group (MPEG-1 or MPEG-2) Audio Layer 3 (MP3) player, and the like, each of them providing a communication service.

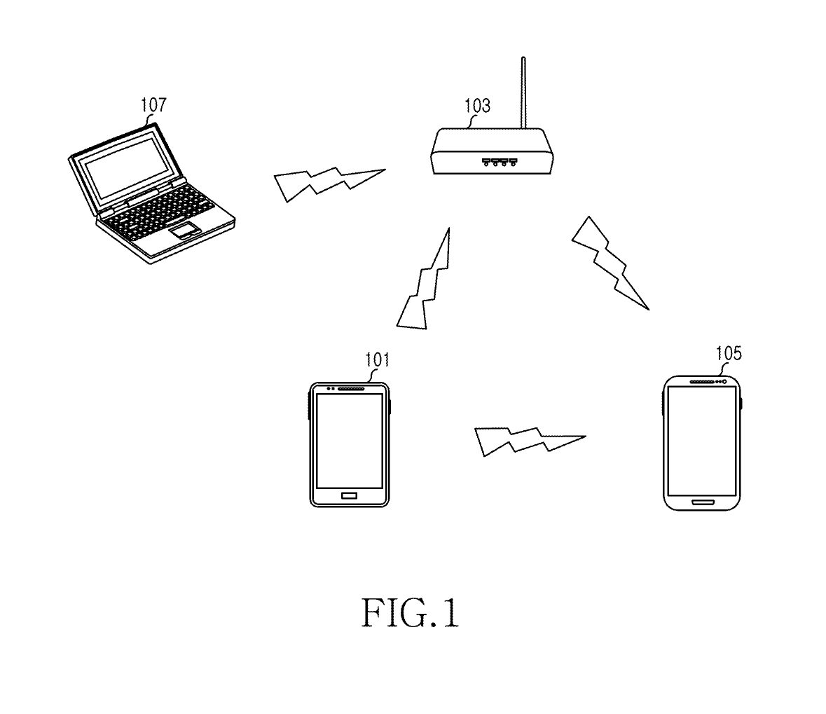

FIG. 1 illustrates a system for controlling connection information according to an embodiment of the present disclosure.

Referring to FIG. 1, an electronic device 101 transmits connection information about a local-area wireless communication device 103 to a counterpart electronic device 105. At this time, the counterpart electronic device 105 performs connection with the local-area wireless communication device 103 using the transmitted connection information.

The electronic device 101 may transmit the connection information about the local-area wireless communication device 103 with authentication information for connecting to a server 107 connected with the local-area wireless communication device 103. At this time, the counterpart electronic device 105 performs connection with the local-area wireless communication device 103 using the transmitted connection information. Thereafter, the counterpart electronic device 105 may connect to the server 107 through the local-area wireless communication device 103. Herein, the server 107 may be included in the electronic device 101.

In addition, the electronic device 101 may set a password to connection information about the local-area wireless communication device 103 and transmit the connection information to the counterpart electronic device 105. In addition, the counterpart electronic device 105 receives authentication information for accessing the server 107 or the electronic device 101, which may operate as the server 107, from the electronic device 101 and stores the received authentication information in its memory. Therefore, when the counterpart electronic device 105 accesses the corresponding server 107 or the corresponding electronic device 101, which may operate as the server 107, the counterpart electronic device 105 may connect to the server 107 or the electronic device 101 without additional authentication.

In addition, the electronic device 101 may transmit connection information including validity information about the connection information to the counterpart electronic device 105 based on at least one of the number of accessible times for the connection information and an accessible period for the connection information.

In addition, the electronic device 101 may determine at least one application program for transmitting connection information to the counterpart electronic device 105. In the transmission of connection information, the electronic device 101 may include information, about an application program which processes the corresponding information in the counterpart electronic device 105, in the connection information.

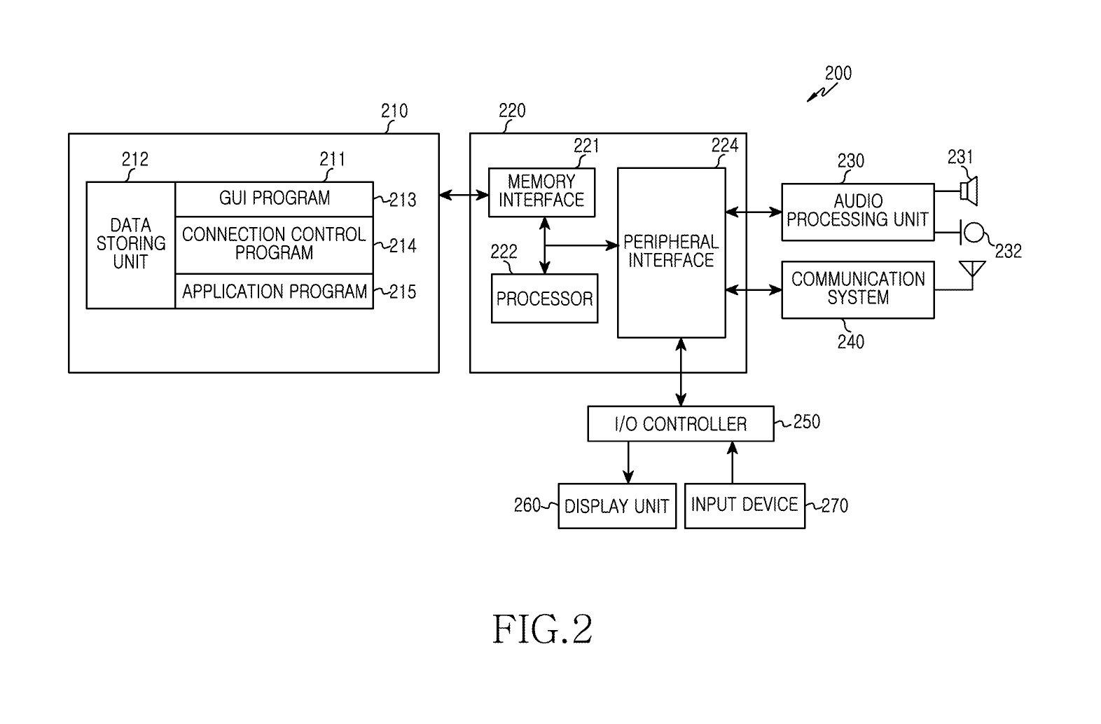

FIG. 2 is a block diagram illustrating a configuration of an electronic device according to an embodiment of the present disclosure.

Referring to FIG. 2, an electronic device denoted by 200 may include a memory 210, a processor 220, an audio processing unit 230, a communication system 240, an Input/Output (I/O) controller 250, a display unit 260, and an input device 270. Herein, the memory 210 may be a plurality of memories.

A description will be given for respective components as follows.

The memory 210 may include a program storing unit 211 for storing programs for controlling operations of the electronic device 200 and a data storing unit 212 for storing data generated while the programs are executed.

The program storing unit 211 may include a Graphical User Interface (GUI) program 213, a connection control program 214, and at least one application program 215. Herein, the programs included in the program storing unit 211 may be expressed in an instruction set as a set of instructions.

The data storing unit 212 may include at least one software component for storing connection information. For example, the data storing unit 212 stores connection information about a local-area wireless communication device. In one example, connection information about a Wi-Fi Access Points (AP) may include at least one of a Service Set IDentification (SSID) of the AP, a Medium Access Control (MAC) address of the AP, authentication types (e.g., a Wi-Fi Protected Access (WPA), a WPA2, and a Wired Equivalent Privacy (WEP)) for the AP, encryption types (e.g., an Advanced Encryption Standard (AES) and a Temporal Key Integrity Protocol (TKIP)), a password for the AP, authentication information about a server, and the like. In another example, connection information about a Bluetooth device may include at least one of a MAC address, a manufacturer, a version, a model name, a password of the Bluetooth device, and the like.

The GUI program 213 may include at least one software component for providing a UI as graphics on the display unit 260. In one example, the GUI program 213 may control the display unit 260 to display a connection information list. In another example, the GUI program 213 may control the display unit 260 to display a security setting window for setting security to connection information. In another example, the GUI program 213 may control the display unit 260 to display a menu for determining whether to perform connection with a local-area wireless communication device. In another example, the GUI program 213 may control the display unit 260 to display a security setting window for releasing security set to connection information.

The connection control program 214 may include at least one software component for transmitting connection information to a counterpart electronic device. For example, when at least one connection information stored in the electronic device 200 is selected, the connection control program 214 transmits the connection information to the counterpart electronic device. Herein, the connection control program 214 may determine at least one application program for transmitting the connection information. In the transmission of the connection information, the connection control program 214 may include authentication information in the connection information. In addition, in the transmission of the connection information, the connection control program 214 may include an access password for the server or the electronic device 201 which operates as the server in the connection information. Moreover, in the transmission of the connection information, the connection control program 214 may include validity information in the connection information.

The connection control program 214 may include at least one software component for performing a connection with at least one local-area wireless communication device using connection information received from the counterpart electronic device.

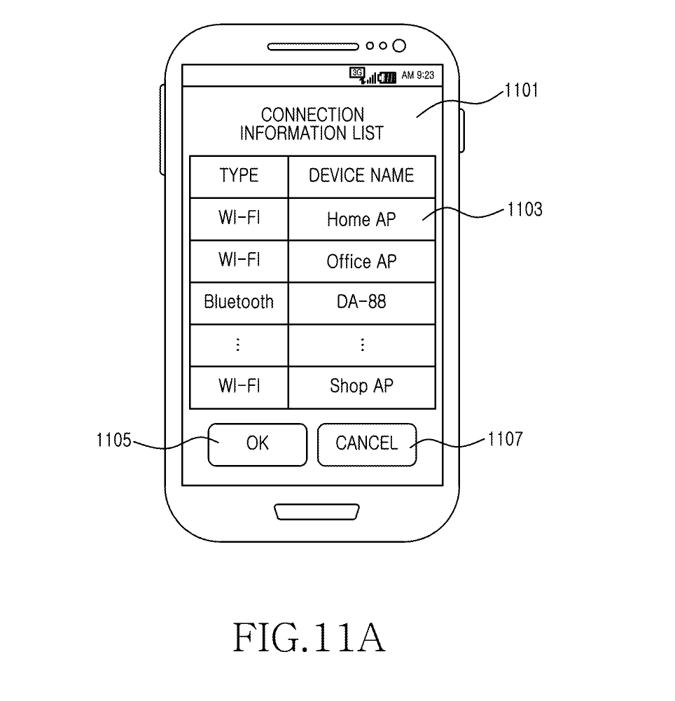

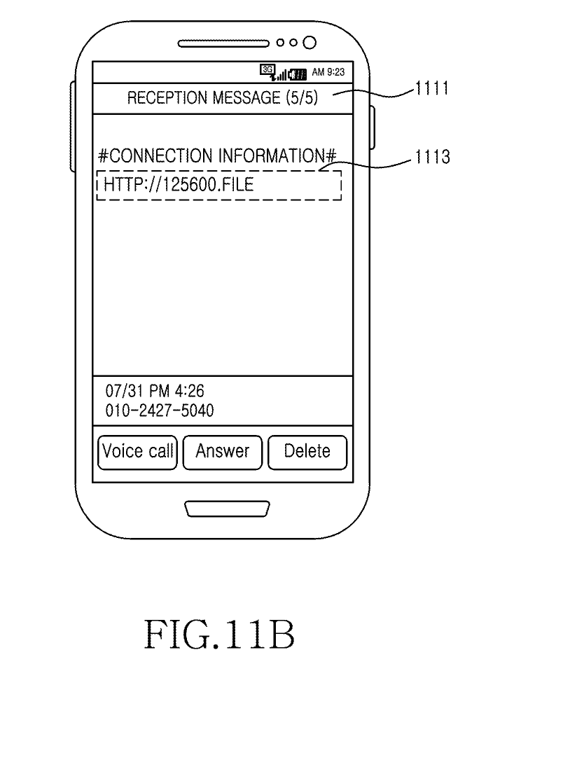

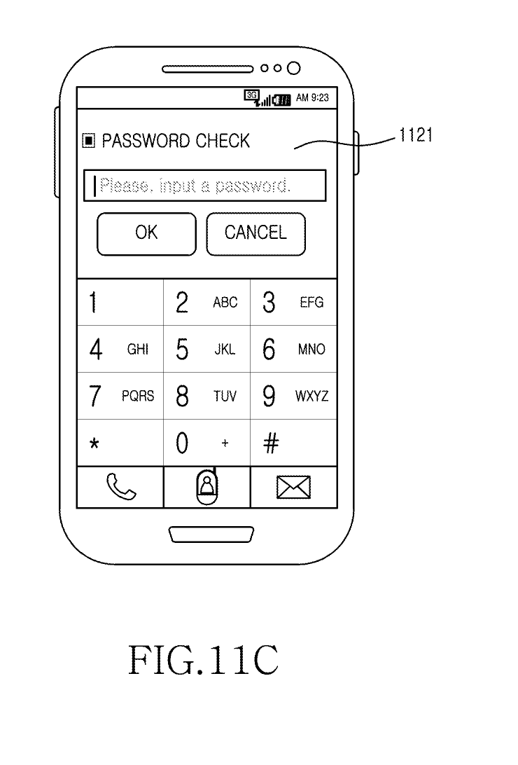

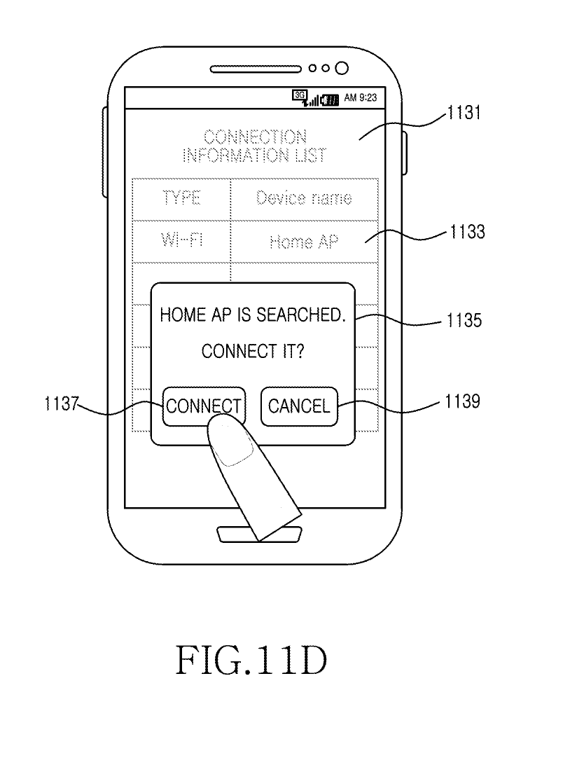

FIGS. 11A, 11B, 11C, and 11D are screens illustrating a process of controlling connection information stored in an electronic device according to an embodiment of the present disclosure.

Referring to FIGS. 11A and 11B, for example, as shown in FIG. 11B, when a link 1113 for receiving connection information through a message application 1111 is selected, the connection control program 214 performs connection with a corresponding electronic device using received connection information. Herein, the connection control program 214 may control the memory 210 to store connection information about at least one local-area wireless communication device and a password for accessing a server on a corresponding local-area wireless network. Upon receiving the connection information, the connection control program 214 may perform an authentication procedure based on authentication information included in the connection information. In addition, upon receiving the connection information, the connection control program 214 may determine validity for the connection information.

The application program 215 may include a software component for at least one application program installed in the electronic device 200.

The processor 220 may include a memory interface 221, at least one processor 222, and a peripheral interface 224. Herein, the memory interface 221, the at least one processor 222, and the peripheral interface 224 which are included in the processor 220 may be integrated in at least one Integrated Circuit (IC) or be separately implemented.

The memory interface 221 may control a component, such as the at least one processor 222, the peripheral interface 224, and the like, to access the memory 210.

The peripheral interface 224 may control a connection among an I/O peripheral of the electronic device 200, the at least one processor 222, and the memory interface 221.

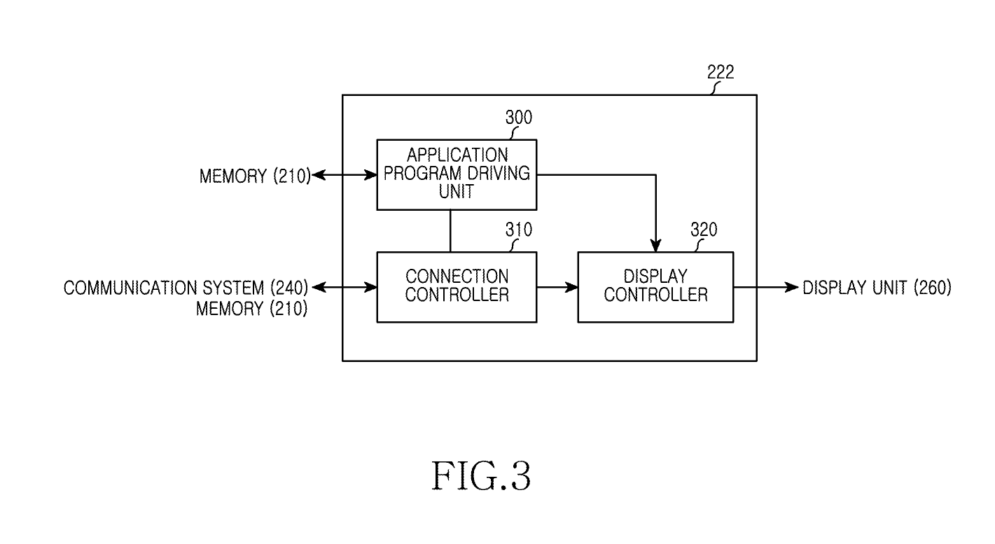

The at least one processor 222 provides a variety of multimedia services using at least one software program. In addition, the at least one processor 222 may execute at least one program stored in the memory 210 and provide a service according to the corresponding program. For example, the at least one processor 222 may be, as shown in FIG. 3, configured to execute the connection control program 214 and control connection information.

The audio processing unit 230 provides an audio interface between a user and the electronic device 200 through a speaker 231 and a microphone 232.

The communication system 240 may include at least one software component for performing a communication function for voice communication and data communication. Herein, the communication system 240 may be classified into a plurality of communication sub-modules which support different communication networks. For example, the communication network may be, but is not limited to, any one of a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a wireless Local Area Network (LAN), a Bluetooth network, a Near Field Communication (NFC) network, and the like.

The I/O controller 250 provides an interface between I/O devices, including the display device 260 and the input device 270, and the peripheral interface 224.

The display unit 260 displays state information of the electronic device 200, characters input by the user, moving pictures, still pictures, and the like. In one example, the display unit 260 displays connection information list according to control of the GUI program 213. In another example, the display unit 260 may display a menu for determining whether to perform connection with a local-area wireless communication device. In another example, the display unit 260 may display an authentication window for performing authentication for connection information according to control of the GUI program 213.

The input device 270 provides input data generated by selection of the user to the processor 220 through the I/O controller 250. In one example, the input device 270 may include a control button for controlling the electronic device 200. In another example, the input device 270 may be configured as a keypad for receiving input data from the user.

If the input device 270 is configured as a touch screen, the input device 270 may further include a touch input unit for providing touch information detected through a touch panel to the processor 220 through the I/O controller 250.

FIG. 3 is a block diagram illustrating a configuration of a processor according to an embodiment of the present disclosure.

Referring to FIGS. 2 and 3, the at least one processor 222 may include an application program driving unit 300, a connection controller 310, and a display controller 320.

The application program driving unit 300 may execute at least one application program 215 stored in the program storing unit 211 and provide a service according to the corresponding application program. Herein, the application program driving unit 300 may provide connection information to the connection controller 310 through at least one application program.

The connection controller 310 may execute the connection control program 214 of the program storing unit 211 and transmit connection information to a counterpart electronic device. For example, when at least one connection information stored in the electronic device is selected, the connection controller 310 transmits the connection information to the counterpart electronic device. Herein, the connection controller 310 may determine at least one application program for transmitting the connection information. In addition, the connection controller 310 may include information about an application program which processes connection information in the counterpart electronic device. Moreover, the connection controller 310 may set security to connection information and transmit the set connection information to the counterpart electronic device. Furthermore, the connection controller 310 may include authentication information, for accessing a server or the electronic device which operates as the server, in the connection information. In the transmission of the connection information, the connection controller 310 may include validity information in the connection information. Herein, the electronic device may include validity information about the connection information based on the number of accessible times for the connection information and an accessible period for the connection information.

In one example, the electronic device may count the number of times that corresponding authentication information is transmitted and determine whether the number of the counted times reaches the number of transmissible times. In another example, the electronic device may determine connection information as valid connection information when the connection information is used within a certain time based on information about a time when the connection information is generated and determine that the corresponding connection information is not valid after the certain time. In addition, the electronic device may include validity information about the connection information in the connection information using at least one of a MAC address, a device ID, and a phone number of a specific electronic device which receives the connection information to use the connection information in the specific electronic device.

The connection controller 310 may execute the connection control program 214 of the program storing unit 211 and perform connection with at least one local-area wireless communication device using connection information received from the counterpart electronic device. For example, as shown in FIG. 11B, when a link 1113 for receiving connection information through a message application 1111 is selected, the connection controller 310 performs connection with a corresponding electronic device using the received connection information. Herein, the connection controller 310 may control the memory 210 to store connection information about at least one local-area wireless communication device and authentication information for accessing a server on a corresponding local-area wireless network. In addition, the connection controller 310 may perform a procedure for releasing security settings set to the connection information. Upon receiving the connection information, the connection controller 310 may determine validity for the connection information.

The display controller 320 may execute the GUI program 213 of the program storing unit 211 and provide a UI as graphics on the display unit 260. In one example, the display controller 320 may control the display unit 260 to display a connection information list. In another example, the display controller 320 may control the display unit 260 to display a security setting window for setting security to connection information. In another example, the display controller 320 may control the display unit 260 to display a menu for determining whether to perform connection with a local-area wireless communication device. In another example, the display controller 320 may control the display unit 260 to display a security setting window for releasing security set to connection information.

In above-described embodiment of the present disclosure, the connection controller 310 of the electronic device may execute the connection control program 214 and control the connection information.

In another embodiment of the present disclosure, the electronic device may include a separate connection control module including the connection control program 214.

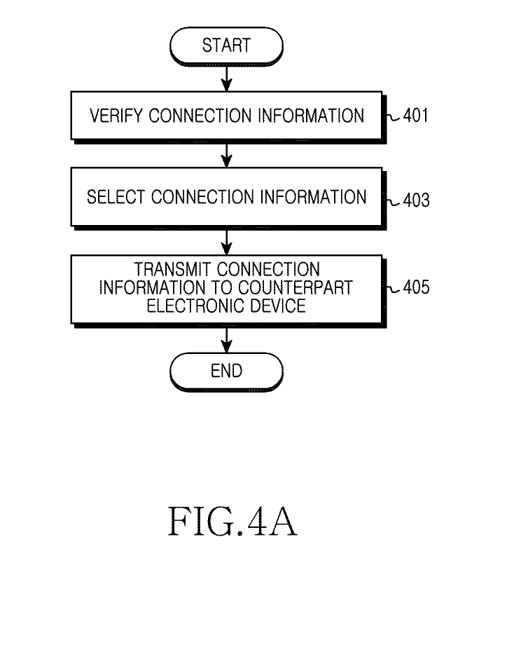

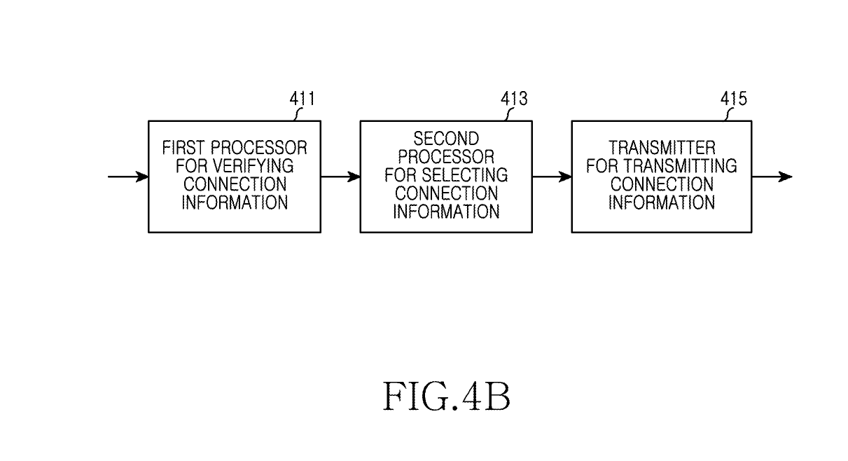

FIG. 4A is a flowchart illustrating a process of transmitting connection information to a counterpart electronic device in an electronic device according to an embodiment of the present disclosure.

Referring to FIG. 4A, in operation 401, the electronic device determines at least one connection information stored therein. For example, when a connection information generation event is generated, the electronic device displays, as shown in FIG. 11A, a connection information list 1101 including connection information with a local-area wireless communication device on a display unit. In one example, in the transmission of connection information about a Wi-Fi AP, the connection information may include at least one of an SSID of the AP, a MAC address of the AP, authentication types (e.g., a WPA, a WPA2, and a WEP) for the AP, encryption types (e.g., an AES and a TKIP), a password for the AP, and the like. In another example, in the transmission of connection information about a Bluetooth device, the connection information may include at least one of a MAC address, a manufacturer, a version, a model name, a password of the Bluetooth device, and the like.

After determining the connection information, in operation 403, the electronic device selects at least one connection information to be transmitted to a counterpart electronic device. For example, as shown in FIG. 11A, the electronic device determines at least one connection information 1103 selected by a user among connection information included in a connection information list 1101.

After selecting the connection information, in operation 405, the electronic device transmits the connection information to the counterpart electronic device. For example, as shown in FIG. 11A, when an “OK” menu 1105 is selected, the electronic device transmits connection information including the at least one selected connection information to the counterpart electronic device. On the other hand, when a selection for a “CANCEL” menu 1107 is detected, the electronic device cancels transmission of the connection information to the counterpart electronic device. Herein, it is assumed that the electronic device generates a file by encoding the connection information.

In addition, the electronic device may determine at least one application program for transmitting the connection information. In addition, the electronic device may include information about an application program for processing the connection information in the counterpart electronic device.

In addition, the electronic device may transmit connection information including authentication information for accessing a server or an electronic device which operates as the server to the counterpart electronic device.

Thereafter, the electronic device ends the algorithm of FIG. 4A.

As described above, the process of transmitting the connection information from the electronic device to the counterpart electronic device may be configured, as shown in FIG. 4B, as an apparatus for transmitting the connection information to the counterpart electronic device.

FIG. 4B is a block diagram illustrating a configuration of an electronic device for transmitting connection information to a counterpart electronic device according to an embodiment of the present disclosure.

Referring to FIG. 4B, the electronic device may include a first processor 411 for determining the connection information, a second processor 413 for selecting the connection information, and a transmitter 415 for transmitting the connection information.

The first processor 411 determines at least one connection information stored in the electronic device. For example, when a connection information generation event is generated, the first processor 411 displays, as shown in FIG. 11A, a connection information list 1101 including connection information with a local-area wireless communication device on a display unit. In one example, in the transmission of connection information about a Wi-Fi AP, the connection information may include at least one of an SSID of the AP, a MAC address of the AP, authentication types (e.g., a WPA, a WPA2, and a WEP) for the AP, encryption types (e.g., an AES and a TKIP), a password for the AP, and the like. In another example, in the transmission of connection information about a Bluetooth device, the connection information may include at least one of a MAC address, a manufacturer, a version, a model name, a password of the Bluetooth device, and the like.

The second processor 413 selects at least one connection information to be transmitted to a counterpart electronic device. For example, as shown in FIG. 11A, the second processor 413 determines at least one connection information 1103 selected by a user among connection information included in the connection information list 1101.

The transmitter 415 transmits the connection information to the counterpart electronic device. For example, as shown in FIG. 11A, when an “OK” menu 1105 is selected, the transmitter 415 transmits connection information including the at least one selected connection information to the counterpart electronic device. Herein, it is assumed that the transmitter 415 generates a file by encoding the connection information.

In addition, the transmitter 415 may determine at least one application program for transmitting the connection information. Moreover, the transmitter 415 may include information about an application program for processing the connection information in the counterpart electronic device.

In addition, the transmitter 415 may transmit connection information including authentication information for accessing a server or an electronic device which operates as the server to the counterpart electronic device.

As described above, the electronic device may include a plurality of transmitters for transmitting connection information to the counterpart electronic device. Herein, the plurality of transmitters for transmitting the connection information to the counterpart electronic device may be configured as one transmitter in the electronic device.

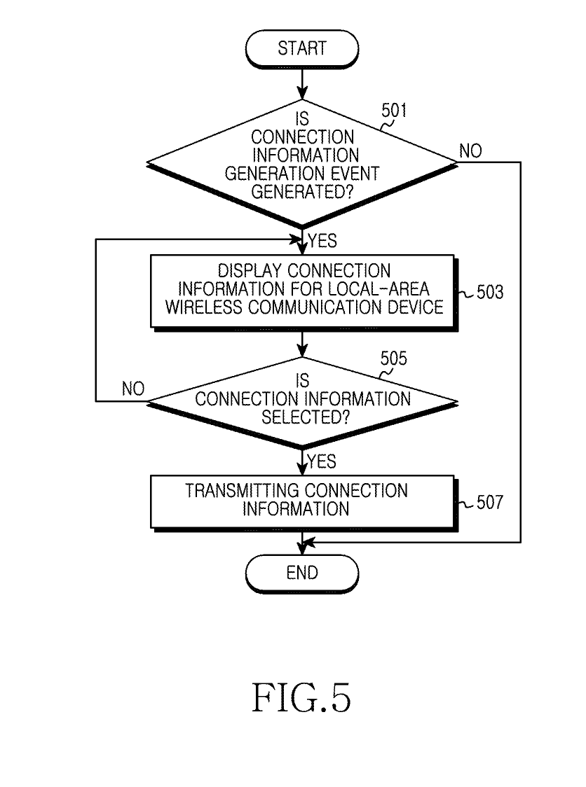

FIG. 5 is a flowchart illustrating a process of transmitting connection information to a counterpart electronic device in an electronic device according to an embodiment of the present disclosure.

Referring to FIG. 5, in operation 501, the electronic device determines whether a connection information generation event is generated. In one example, the electronic device determines whether an icon for generating connection information is selected. In another example, the electronic device may determine whether a connection information generation event is generated based on input information of a hardware button. In another example, the electronic device may determine whether a connection information generation event is generated based on an input button of a hardware button and its motion information. In another example, the electronic device may determine whether a connection information generation event is generated based on touch information on a touch screen. In another example, the electronic device may determine whether a connection information generation event is generated based on touch information on a touch screen and its motion information. If the connection information generation event is not generated, the electronic device ends the algorithm of FIG. 5.

On the other hand, when the connection information generation event is generated, in operation 503, the electronic device displays connection information about a local-area wireless communication device. For example, as shown in FIG. 11A, the electronic device displays a connection information list 1101 including connection information with the local-area wireless communication device on a display unit. In one example, in the transmission of connection information about a Wi-Fi AP, the connection information may include at least one of an SSID of the AP, a MAC address of the AP, authentication types (e.g., a WPA, a WPA2, and a WEP) for the AP, encryption types (e.g., an AES and a TKIP), a password for the AP, and the like. In another example, in the transmission of connection information about a Bluetooth device, the connection information may include at least one of a MAC address, a manufacturer, a version, a model name, a password of the Bluetooth device, and the like.

After displaying the connection information about the local-area wireless communication device, in operation 505, the electronic device determines whether the connection information is selected. For example, as shown in FIG. 11A, the electronic device determines at least one connection information 1103 selected by a user among connection information included in a connection information list 1101. If the connection information is not selected, the electronic device proceeds to operation 503 and holds the display of the connection information about the local-area wireless communication device.

On the other hand, when the connection information is selected, in operation 507, the electronic device transmits the connection information to a counterpart electronic device. For example, as shown in FIG. 11A, when an “OK” menu 1105 is selected, the electronic device transmits connection information including the at least one selected connection information to the counterpart electronic device. Herein, it is assumed that the electronic device generates a file by encoding the connection information.

In addition, the electronic device may determine at least one application program for transmitting the connection information. Moreover, the electronic device may include information about an application program for processing the connection information in the counterpart electronic device.

In addition, the electronic device may transmit connection information including authentication information for accessing a server or an electronic device which operates as the server to the counterpart electronic device.

Thereafter, the electronic device ends the algorithm of FIG. 5.

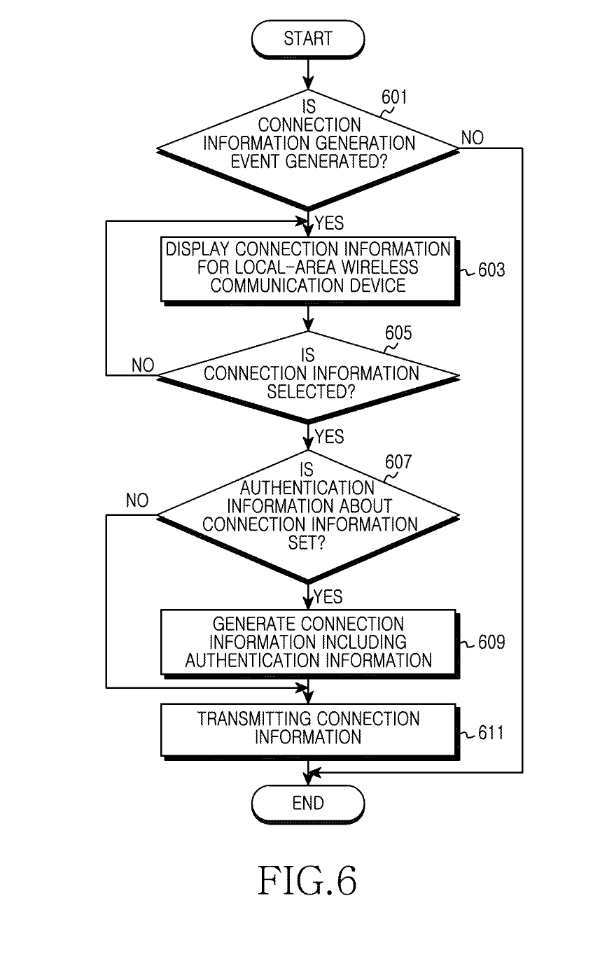

FIG. 6 is a flowchart illustrating a process of transmitting connection information including authentication information to a counterpart electronic device in an electronic device according to an embodiment of the present disclosure.

Referring to FIG. 6, in operation 601, the electronic device determines whether a connection information generation event is generated. In one example, the electronic device determines whether an icon for generating connection information is selected. In another example, the electronic device may determine whether a connection information generation event is generated based on input information of a hardware button. In another example, the electronic device may determine whether a connection information generation event is generated based on an input button of a hardware button and its motion information. In another example, the electronic device may determine whether a connection information generation event is generated based on touch information on a touch screen. In another example, the electronic device may determine whether a connection information generation event is generated based on touch information on a touch screen and its motion information. If the connection information generation event is not generated, the electronic device ends the algorithm of FIG. 6.

On the other hand, when the connection information generation event is generated, in operation 603, the electronic device displays connection information about a local-area wireless communication device. For example, as shown in FIG. 11A, the electronic device displays a connection information list 1101 including connection information with the local-area wireless communication device on a display unit. In one example, in the transmission of connection information about a Wi-Fi AP, the connection information may include at least one of an SSID of the AP, a MAC address of the AP, authentication types (e.g., a WPA, a WPA2, and a WEP) for the AP, encryption types (e.g., an AES and a TKIP), a password for the AP, and the like. In another example, in the transmission of connection information about a Bluetooth device, the connection information may include at least one of a MAC address, a manufacturer, a version, a model name, a password of the Bluetooth device, and the like.

After displaying the connection information about the local-area wireless communication device, in operation 605, the electronic device determines whether the connection information is selected. For example, as shown in FIG. 11A, the electronic device determines at least one connection information 1103 selected by a user among connection information included in the connection information list 1101. If the connection information is not selected, the electronic device proceeds to operation 603 and holds the display of the connection information about the local-area wireless communication device.

On the other hand, when the connection information is selected, in operation 607, the electronic device determines whether to set security to the connection information. For example, as shown in FIG. 11A, when an “OK” menu 1105 is selected, the electronic device may set security connection information based on at least one key input by the user. If the security for the connection information is not set, the electronic device proceeds to operation 611 and transmits the connection information to a counterpart electronic device.

On the other hand, when the security is set to the connection information, in operation 609, the electronic device generates connection information to which the security is set. Herein, the electronic device may include authentication information for accessing a server or an electronic device which operates as the server.

After generating the connection information to which the security is set, in operation 611, the electronic device transmits the connection information to the counterpart electronic device. For example, the electronic device transmits connection information including the at least one connection information to the counterpart electronic device. Herein, it is assumed that the electronic device generates a file by encoding the connection information.

In addition, the electronic device may determine at least one application program for transmitting the connection information. Moreover, the electronic device may include information about an application program for processing the connection information in the counterpart electronic device.

In addition, the electronic device may transmit connection information including authentication information for accessing a server or an electronic device which operates as the server to the counterpart electronic device.

Thereafter, the electronic device ends the algorithm of FIG. 6.

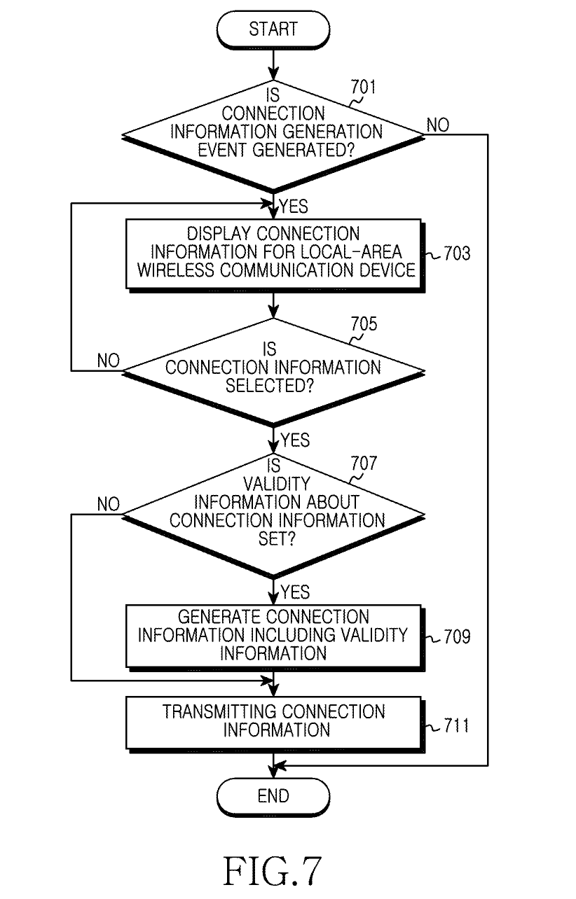

FIG. 7 is a flowchart illustrating a process of transmitting connection information including validity information to a counterpart electronic device in an electronic device according to an embodiment of the present disclosure.

Referring to FIG. 7, in operation 701, the electronic device determines whether a connection information generation event is generated. In one example, the electronic device determines whether an icon for generating connection information is selected. In another example, the electronic device may determine whether a connection information generation event is generated based on input information of a hardware button. In another example, the electronic device may determine whether a connection information generation event is generated based on an input button of a hardware button and its motion information. In another example, the electronic device may determine whether a connection information generation event is generated based on touch information on a touch screen. In another example, the electronic device may determine whether a connection information generation event is generated based on touch information on a touch screen and its motion information. If the connection information generation event is not generated, the electronic device ends the algorithm of FIG. 7.

On the other hand, when the connection information generation event is generated, in operation 703, the electronic device displays connection information about a local-area wireless communication device. For example, as shown in FIG. 11A, the electronic device displays a connection information list 1101 including connection information with the local-area wireless communication device on a display unit. In one example, in the transmission of connection information about a Wi-Fi AP, the connection information may include at least one of an SSID of the AP, a MAC address of the AP, authentication types (e.g., a WPA, a WPA2, and a WEP) for the AP, encryption types (e.g., an AES and a TKIP), a password for the AP, and the like. In another example, in the transmission of connection information about a Bluetooth device, the connection information may include at least one of a MAC address, a manufacturer, a version, a model name, a password of the Bluetooth device, and the like.

After displaying the connection information about the local-area wireless communication device, in operation 705, the electronic device determines whether the connection information is selected. For example, as shown in FIG. 11A, the electronic device determines at least one connection information 1103 selected by a user among connection information included in a connection information list 1101. If the connection information is not selected, the electronic device proceeds to operation 703 and holds the display of the connection information about the local-area wireless communication device.

On the other hand, when the connection information is selected, in operation 707, the electronic device determines whether to set validity information about the connection information. If the validity information about the connection information is not set, the electronic device proceeds to operation 711 and transmits the connection information to a counterpart electronic device.

On the other hand, when the validity information about the connection information is set, in operation 709, the electronic device generates connection information including the validity information. In one example, the electronic device generates the connection information including the validity information about the connection information based on at least one of the number of accessible times for the connection information and an accessible period for the connection information. In another example, the electronic device may generate the connection information including the validity information about the connection information based on at least one of a MAC address, a device ID, and a phone number of an electronic device which receives the connection information to use the connection information in a specific electronic device.

After generating the connection information including the validity information, in operation 711, the electronic device transmits the connection information to the counterpart electronic device. For example, the electronic device transmits connection information including the at least one connection information to the counterpart electronic device. Herein, it is assumed that the electronic device generates a file by encoding the connection information.

In addition, the electronic device may determine at least one application program for transmitting the connection information. Moreover, the electronic device may include information about an application program for processing the connection information in the counterpart electronic device.

In addition, the electronic device may transmit connection information including authentication information for accessing a server or an electronic device which operates as the server to the counterpart electronic device.

Thereafter, the electronic device ends the algorithm of FIG. 7.

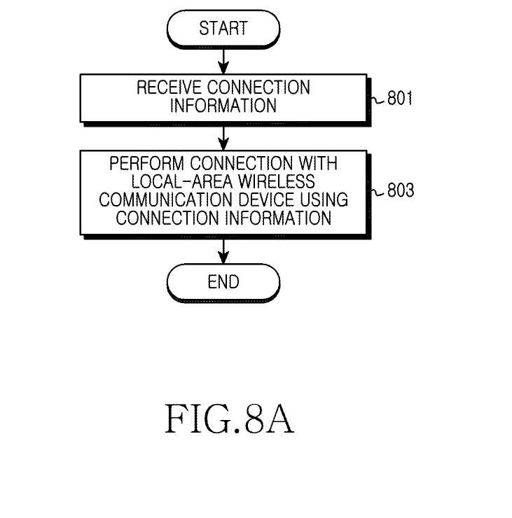

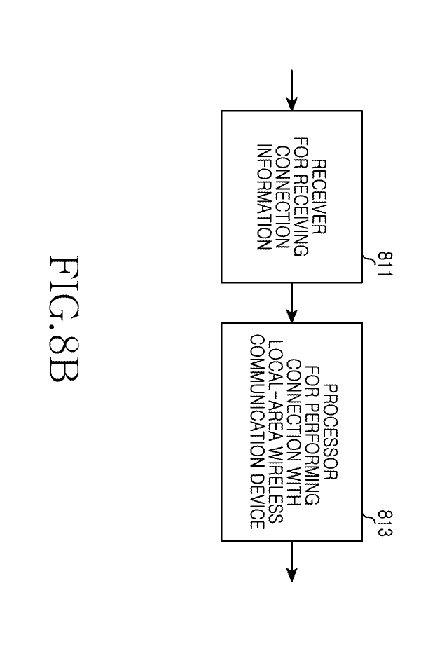

FIG. 8A is a flowchart illustrating a process of performing a connection with a local-area wireless communication device using connection information received from a counterpart electronic device in an electronic device according to an embodiment of the present disclosure.

Referring to FIG. 8A, in operation 801, the electronic device receives the connection information from the counterpart electronic device. For example, as shown in FIG. 11B, the electronic device receives a message including a link 1113, which may receive connection information through a message application program 1111.

After receiving the connection information, in operation 803, the electronic device performs connection with a local-area wireless communication device using the connection information. For example, as shown in FIG. 11B, when the link 1113, which may receive the connection information, is selected in the message application program 1111, the electronic device perform connection with a corresponding electronic device using the received connection information. Herein, the electronic device may add, as shown in FIG. 11D, a “Home AP” 1133 to a connection list 1131 for at least one local-area wireless communication device.

In addition, the electronic device may store authentication information for accessing a server or an electronic device which operates as the server in a memory.

Thereafter, the electronic device ends the algorithm of FIG. 8A.

As described above, the process of performing the connection with the local-area wireless communication device using the connection information received from the counterpart electronic device in the electronic device may be configured, as shown in FIG. 8B, as an apparatus for performing the connection with the local-area wireless communication device using the connection information received from the counterpart electronic device in the electronic device.

FIG. 8B is a block diagram illustrating a configuration of an electronic device for performing a connection with a local-area wireless communication device using connection information received from a counterpart electronic device according to an embodiment of the present disclosure.

Referring to FIG. 8B, the electronic device may include a receiver 811 for receiving connection information and a processor 813 for performing a connection with a local-area wireless communication device.

The receiver 811 receives the connection information from the counterpart electronic device. For example, as shown in FIG. 11B, the receiver 811 receives a message including a link 1113, which may receive connection information through a message application program 1111.

The processor 813 performs the connection with the local-area wireless communication device using the connection information. For example, as shown in FIG. 11B, when the link 1113, which may receive the connection information, is selected in the message application program 1111, the processor 813 performs the connection with a corresponding electronic device using the received connection information. Herein, the processor 813 may add, as shown in FIG. 11D, a “Home AP” 1133 to a connection list 1131 for at least one local-area wireless communication device.

In addition, the processor 813 may store authentication information for accessing a server or an electronic device which operates as the server in a memory.

As described above, the electronic device may include a plurality of processors for performing a connection with the local-area wireless communication device using the connection information received from the counterpart electronic device in the electronic device. Herein, the plurality of processors for performing the connection with the local-area wireless communication device using the connection information received from the counterpart electronic device in the electronic device may be configured as one processor.

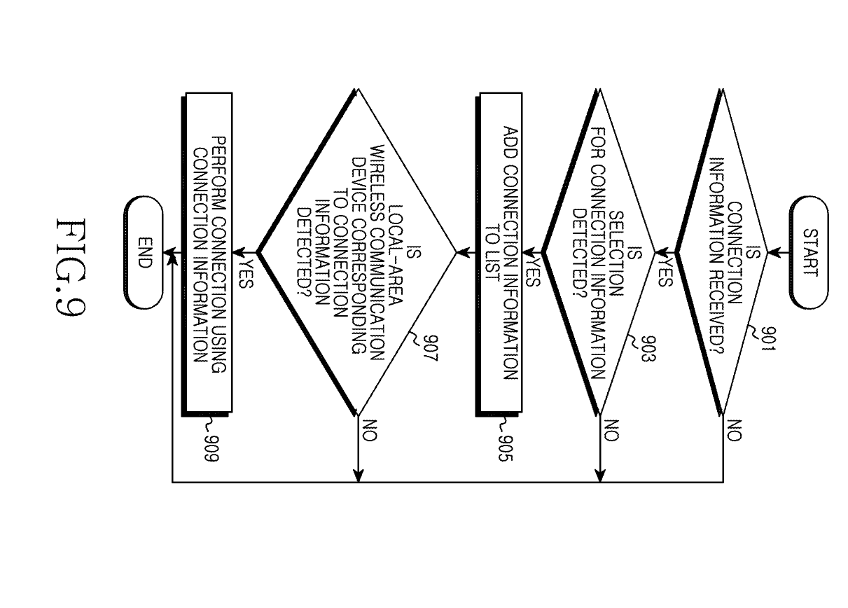

FIG. 9 is a flowchart illustrating a process of performing a connection with a local-area wireless communication device using connection information received from a counterpart electronic device in an electronic device according to an embodiment of the present disclosure.

Referring to FIG. 9, in operation 901, the electronic device determines whether connection information is received. For example, as shown in FIG. 11B, the electronic device determines whether a message including a link 1113, which may receive connection information through a message application program 1111, is received. If the connection information is not received, the electronic device ends the algorithm of FIG. 9.

On the other hand, when the connection information is received, in operation 903, the electronic device determines whether selection for the connection information is detected. For example, as shown in FIG. 11B, the electronic device determines whether the link 1113, which may receive the connection information, is selected in the message application program 1111. If the selection for the connection information is not detected, the electronic device ends the algorithm of FIG. 9.

On the other hand, when the selection for the connection information is detected, in operation 905, the electronic device adds the connection information to a list. For example, as shown in FIG. 11B, when the link 1113, which may receive the connection information, is selected in the message application program 1111, the electronic device adds, as shown in FIG. 11D, a “Home AP” 1133 to a connection list 1131 for at least one local-area wireless communication device.

After adding the connection information to the list, in operation 907, the electronic device determines whether a local-area wireless communication device corresponding to the connection information is detected. In one example, as shown in FIG. 11D, when the “Home AP” 1133 is selected on the connection list 1131 for the local-area wireless communication device, the electronic device displays a menu 1135 for connecting the “Home AP” 1133. Herein, when a selection for a “CONNECT” menu 1137 is detected, the electronic device executes connection of the “Home AP” 1133. On the other hand, when a selection for a “CANCEL” menu 1139 is detected, the electronic device cancels connection of the “Home AP” 1133. In another example, the electronic device may determine whether a corresponding electronic device is automatically detected after connection information is added to a list. If the local-area wireless communication device corresponding to the connection information is not detected, the electronic device ends the algorithm of FIG. 9.

On the other hand, when the local-area wireless communication device corresponding to the connection information is detected, in operation 909, the electronic device performs connection using the connection information.

In addition, the electronic device may store authentication information for accessing a server or an electronic device which operates as the server in a memory.

Thereafter, the electronic device ends the algorithm of FIG. 9.

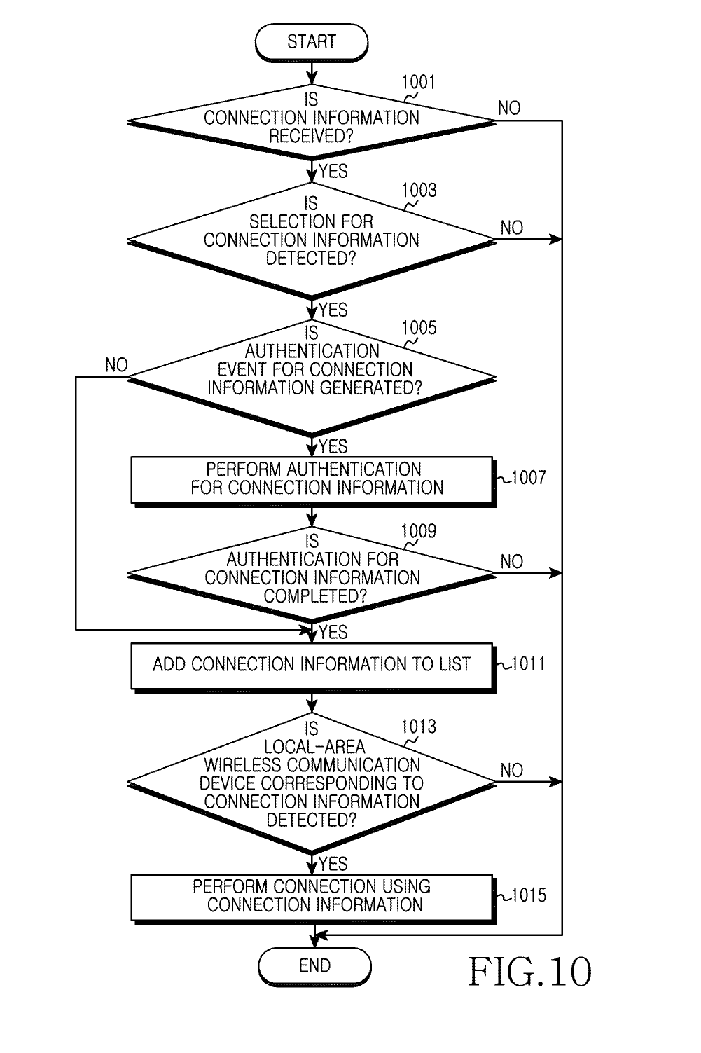

FIG. 10 is a flowchart illustrating a process of performing a connection with a local-area wireless communication device using connection information including authentication information received from a counterpart electronic device in an electronic device according to an embodiment of the present disclosure.

Referring to FIG. 10, in operation 1001, the electronic device determines whether connection information is received. For example, as shown in FIG. 11B, the electronic device determines whether a message including a link 1113, which may receive connection information through a message application program 1111, is received. If the connection information is not received, the electronic device ends the algorithm of FIG. 10.

When the connection information is received, in operation 1003, the electronic device determines whether selection for the connection information is detected. For example, as shown in FIG. 11B, the electronic device determines whether the link 1113, which may receive the connection information, is selected in the message application program 1111. If the selection for the connection information is not detected, the electronic device ends the algorithm of FIG. 10.

On the other hand, when the selection for the connection information is detected, in operation 1005, the electronic device determines whether security is set to the connection information. For example, as shown in FIG. 11B, when the link 1113, which may receive the connection information, is selected in the message application program 1111, the electronic device determines whether the security is set to the connection information. If the security is not set to the connection information, the electronic device proceeds to operation 1011 and adds the connection information to a list.

On the other hand, when the security is set to the connection information, in operation 1007, the electronic device performs a release procedure to the security set to the connection information.

Referring to FIG. 11C, for example, when the security is set to the connection information, the electronic device determines a password 1121 input by a user.

After performing the release procedure to the security set to the connection information, in operation 1009, the electronic device determines whether the release procedure is completed to the security set to the connection information. For example, the electronic device determines whether a password included in the connection information is identical to the password input by the user. If the release procedure is not completed to the security set to the connection information, the electronic device ends the algorithm of FIG. 10.

On the other hand, when the release procedure is completed to the security set to the connection information, in operation 1011, the electronic device adds the connection information to a list.

Referring to FIG. 11D, for example, the electronic device adds a “Home AP” 1133 to a connection list 1131 for at least one local-area wireless communication device.

After adding the connection information to the list, in operation 1013, the electronic device determines whether a local-area wireless communication device corresponding to the connection information is detected. For example, as shown in FIG. 11D, when the “Home AP” 1133 is selected on the connection list 1131 for the local-area wireless communication device, the electronic device displays a menu 1135 for connecting the “Home AP” 1133. Herein, when a selection for a “CONNECT” menu 1137 is detected, the electronic device executes connection of the “Home AP” 1133. On the other hand, when a selection for a “CANCEL” menu 1139 is detected, the electronic device cancels connection of the “Home AP” 1133. In another example, the electronic device may determine whether a corresponding electronic device is automatically detected after the connection information is added to the list. If the local-area wireless communication device corresponding to the connection information is not detected, the electronic device ends the algorithm of FIG. 10.

On the other hand, when the local-area wireless communication device corresponding to the connection information is detected, in operation 1015, the electronic device performs connection using the connection information.

In addition, the electronic device may store authentication information for accessing a server or an electronic device, which operates as the server, in a memory.

In addition, when a selection for the connection information is detected, the electronic device may determine whether the connection information is valid based on at least one of the number of accessible times for the connection information and an accessible period for the connection information.

Thereafter, the electronic device ends the algorithm of FIG. 10.

As described above, the electronic device may perform connection with the local-area wireless communication device by receiving the connection information and performing the connection with the local-area wireless communication device using the connection information.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling connection information stored in an electronic device, the method comprising:
determining the connection information, for at least one local-area wireless communication device, stored in the electronic device;
selecting the connection information, for the at least one local-area wireless communication device, to be transmitted to a counterpart electronic device; and
transmitting the connection information to the counterpart electronic device.

2. The method of claim 1, further comprising encoding authentication information for accessing a server and adding the encoded authentication information in the connection information, when transmitting the connection information to the counterpart electronic device.

3. The method of claim 1, further comprising setting security to the connection information and transmitting the connection information to which the security is set to the counterpart electronic device, when transmitting the connection information to the counterpart electronic device.

4. The method of claim 1, further comprising adding validity information about the connection information based on at least one of the number of accessible times for the connection information and an accessible period for the connection information, when transmitting the connection information to the counterpart electronic device.

5. The method of claim 1, further comprising determining at least one application program for transmitting the connection information to the counterpart electronic device, when transmitting the connection information to the counterpart electronic device.

6. A method for controlling connection information stored in an electronic device, the method comprising:
receiving connection information for at least one local-area wireless communication device from a counterpart electronic device; and
performing a connection with the at least one local-area wireless communication device using the connection information.

7. The method of claim 6, further comprising storing the connection information, when receiving the connection information.

8. The method of claim 6, further comprising decoding and storing authentication information, for accessing a server, added in the connection information, when receiving the connection information.

9. The method of claim 6, further comprising performing authentication for the connection information, when receiving the connection information.

10. The method of claim 6, further comprising determining validity for the connection information based on at least one of the number of accessible times for the connection information and an accessible period for the connection information, when receiving the connection information.

11. An electronic device comprising:
at least one processor;
a memory; and
at least one program stored in the memory and configured to be executable by the at least one processor,
wherein the at least one processor determines connection information, for at least one local-area wireless communication device, stored in the electronic device, selects the connection information, for the at least one local-area wireless communication device, to be transmitted to a counterpart electronic device, and transmits the connection information to the counterpart electronic device.

12. The electronic device of claim 11, wherein the at least one processor encodes authentication information for accessing a server and adds the encoded authentication information in the connection information.

13. The electronic device of claim 11, wherein the at least one processor sets security to the connection information and transmits the connection information to which the security is set to the counterpart electronic device.

14. The electronic device of claim 11, wherein the at least one processor adds validity information about the connection information based on at least one of the number of accessible times for the connection information and an accessible period for the connection information.

15. The electronic device of claim 11, wherein the at least one processor determines at least one application program for transmitting the connection information to the counterpart electronic device.

16. An electronic device comprising:
at least one processor;
a memory; and
at least one program stored in the memory and configured to be executable by the at least one processor,
wherein the at least one processor receives connection information for at least one local-area wireless communication device from a counterpart electronic device and performs connection with the at least one local-area wireless communication device using the connection information.

17. The electronic device of claim 16, wherein the at least one processor stores the connection information.

18. The electronic device of claim 16, wherein the at least one processor decodes and stores authentication information, for accessing a server, added in the connection information.

19. The electronic device of claim 16, wherein the at least one processor performs authentication for the connection information.

20. The electronic device of claim 16, wherein the at least one processor determines validity for the connection information based on at least one of the number of accessible times for the connection information and an accessible period for the connection information.

21. A non-transitory computer readable medium for storing a computer program of instructions configured to be readable by at least one processor for instructing the at least one processor to execute a computer process for performing the method of claim 1.
